(19) United States
(12) Patent Application Publication
(10) Pub. No.: US 2011/0221093 A1
(43) Pub. Date: Sep. 15, 2011

(54) METHOD AND SYSTEM FOR MANUFACTURING WIND TURBINE BLADES

(76) Inventors: Nathaniel Perrow, Lynchburg, VA (US); James Ray Starr, Atlavista, VA (US); Matthew Ryan Baker, Richmond, VA (US)

(21) Appl. No.: 12/723,241

(22) Filed: Mar. 12, 2010

(51) Int. Cl. B29C 33/58

(52) U.S. Cl. 264/255; 425/89

(57) ABSTRACT

A method and system for making and forming turbine blades. The method and system can include steps for determining stress loads on amore turbine blades; constructing one or more molds for components of the turbine blade in which a turbine-forming substance is injected; applying a resin to an interior portion of the one or more molds; forming one or more partitions within the one or more molds; coupling the one or more molds; injecting the blade-forming substance into the coupled one or more molds; regulating the pressure in the coupled one or more molds; voiding any excess air or resin in the coupled one or more molds; and allowing the blade-forming substance injected into the coupled one or more molds to harden.

### BACKGROUND

A variety of problems can exist in the manufacture of medium to large scale wind turbine blades used for wind turbines, such as three bladed horizontal axis wind turbines. They include: difficulty of production, a large amount of materials and equipment needed to produce the blades and difficulty in transporting a finished turbine blade from a factory to an assembly site.

Wind turbine blades are typically produced in one of two ways: open mold-based technology and closed mold vacuum infusion. Open mold processes rely on an open, one-sided mold which is produced as one half of an engineered turbine blade. Initially, the mold is coated with mold release products such as Chemlease®, a registered trademark of Chembar, Inc. of Ohio, which will let the finished part be removed from the mold. In a new mold, multiple applications of mold release must be applied until the product has penetrated the mold surfaces. Chemlease®, can be described as a liquid semi-permanent mold release. Application would typically involve saturating an applicator, such as a towel or cloth, with the mold release and then using the applicator to coat the inside of the mold. The coating should be applied evenly and thoroughly to the entire mold surface. Upon application, a hazy, opaque coating may be evident. When this is uniform in appearance on the entire mold surface, the mold has been properly prepped with mold release.

The gel-coat stage can be the next step in the construction of a laminate. After the mold release has been applied the gel-coat process may begin. The gel-coat is a cosmetic process that gives the laminate a smooth uniform finish. Gel-coating is important especially for wind turbine blade applications because it promotes a smooth, finished surface. Such a surface reduces drag and enhances desirable aerodynamic performance characteristics of a wind turbine blade. A gel-coating apparatus is similar to a paint sprayer, but is specifically designed for the spraying of a catalyzed resin formulated for gel-coat applications. Equipment suitable for gel-coating is available from Magnum Venus Plastech Company, such as its Patriot system. This is a high velocity, low pressure pumping system that mixes the catalyst with the gel-coat resin (typically a pigmented, polyester base resin). The pump system drives the gel-coat resin to the gun, while simultaneously pumping a predetermined ratio of catalyst, via a slave arm cylinder pump, into the line which feeds the gel-coat gun. The spray gun atomizes the gel-coat, and when used by a knowledgeable operator, can uniformly spray the gel-coat into the prepped mold surface. Then a gel coat is applied by spraying in an accepted spray pattern such as having the operator directionally spray to the right, covering the portion of the mold to be gel-coated, then a second pass is made on the previously sprayed portion of the mold, this time the operator is spraying in a downward pattern. A third pass is made in which the operator sprays in a left direction. Once these three passes have been made, the operator moves on (usually in a pattern from bottom to top, or lowest part of the mold to the highest part) to spray the remainder of the mold surfaces. The operator generally starts spraying from the bottom portion of the mold in order to minimize any smudging that may result from re-coating a previously coated mold surface. This process continues until a desired predetermined thickness is achieved. Typically, this thickness is approximately 20 mm. This gel-coat is the outer surface of the finished product.

Sometimes, an optional additional step is used in which the gel-coat itself is further coated in another spray application with a protective finish such as Armorguard®, a registered trademark of Cook Composites and Polymers Co. Total Composites, Inc. of Delaware, or a similar product. Usually, this optional coating is applied while the gel-coat is still tacky to the touch and not yet cured and results in a thicker coating on the outside turbine surface. A coating of this nature helps the gel-coat resist cracking and reduces fabric print through from the underlying structural fabric reinforcements.

Once the mold has been prepped with these products, and after they have cured, structural fabric reinforcements are laid up into the mold as specified in the design. The fabric is cut and sized appropriately to ensure a proper drape with no wrinkling. A tackifier product may be used, such as NuTak Blu, available from Cook Composites and Polymers Co. Total Composites, Inc. of Delaware, to hold the fabric temporarily in place while a worker manually impregnates the fabric, typically using an isophtalic polyester resin formulated for infusion which may be customized for such open mold operations. The worker typically dips a small hand held paint roller into a pot of the resin and moves the roller across the dry fabric to push the resin into the dry fabric. The worker must carefully ensure total impregnation of the fabric and must also be sure to eliminate any air pockets from the fabric. Alternatively, a pre-pregged fiberglass fabric, meaning one which has been previously wet out with catalyzed resin, may be used. Nevertheless, in the open mold process, the worker is building the laminate layer-by-layer by applying whatever type of fabric is used and then applying catalyzed resin to each layer until the desired thickness is obtained. Once the crosslinking exothermic reaction inherent in the curing of thermoset polymer resins causes the resin to gel, the worker removes any visible excess resin. Aside from the obvious labor intensity, another disadvantage of this method is that it is potentially dangerous as it exposes the worker who is applying the resin to styrene emissions, a volatile organic compound (VOC).

In the vacuum infusion process the initial mold preparation may be identical. The structural fabric reinforcement fabric is again laid up into the mold but is then layered in dry form to achieve the desired thickness and correct ply orientation. A soft nylon sheet such as the KM1300, available from Air Tech Advanced Materials Group of California, is used to cover the dry structural fabric reinforcement fabric. The nylon sheet may be attached using a two-sided tape which is a thick gummy type tape that can hold its shape and could be used to conform to the sides of the mold. It has two peelable protective strips that cover the top and bottom adhesive sides. Such a tape may be obtained from Minnesota Mining and Manufacturing of Minnesota. The nylon sheet is attached to the outer edges of the mold. Generally, a mold of this type has a wide flange that lines the perimeter of the mold in order to assist in the attachment of vacuum bags and provide a wide surface to ensure an adequate vacuum seal. The nylon sheet is pleated as necessary to allow for it to fully cover the part within the mold when a vacuum is introduced. A vacuum is then introduced through a sealed vacuum line which compresses the fabric. When a desired vacuum level has been achieved, resin lines, placed as needed throughout, are opened one at a time, allowing a catalyzed resin to flow into the compressed dry fabric. This process functions according to Darcy's law, a constitutive equation describing the flow of a fluid through a porous medium, thereby enabling calculation of the manner in which the resin flows through the dry fabric. The challenge with this process is to minimize and or eliminate voids and execute a full saturating, wet out of the fabric before the resin begins to gel. Both the open mold and closed mold processes are known, proven methods of constructing laminates.

However, in the open mold process, as mentioned above, styrene emissions are high and can be hazardous to workers with prolonged exposure. In the closed mold process, malfunctions can occur with thick laminates, such as too high an exothermic reaction and/or development of undesired voids. While the closed mold process produces a higher quality, stronger laminate, it is a complex process that involves vacuum pumps, mixing and metering machinery and an array of tubing and sacrificial materials to facilitate the process.

Regardless of whether a closed or open mold process is used, once the part has been produced, it is still just one side of a two-sided turbine blade. Therefore two molded composite halves must first be successfully produced, and then secondarily bonded together with adhesives along the perimeter of the blade halves. And, depending on design of the blade, a separate, protruded, pultruded or filament wound supporting flange or beam needs to be bonded to the interior of the blade halves in order to provide the proper strength. Currently, hollow structures like wind turbine blades are reinforced with thicker material on their outer surfaces and/or the placement of a pre-constructed spar or beam along the middle of the structure. These processes are both man-hour- and machinery-intensive and therefore inherently inefficient. The amount of manufacturing and assembly square footage needed to construct large blade halves and then bond them together can also be very large. In addition, for proper movement of the blades, gantry cranes may be needed, especially for the bonding together of the two blade halves. Where there is movement, there is risk, both to men and materials, and damage can result from improper handling and rigging.

After a finished turbine blade has been produced, the challenge of transport arises. Utility generation turbine blades can exceed 30 meters in length. The transport of these blades can pose logistical problems, especially when they are delivered to a wind farm site. These sites can often be remote and not easily accessible for large trucks with oversized pay loads. This situation necessitates expensive access road construction at the wind farm site. Also each truck may only carry one blade while each typical horizontal axis wind turbine requires three blades. When there are multiple turbines proposed, three trucks may be needed to supply the blades for just one turbine. This transportation can be a significant expense and pose a potential additional risk for the wind farm developer.

A completely different process for producing cured catalyzed resin (i.e., composite structures) is referred to as Cured In Place Pipe technology (CIPP). CIPP is a process in which a resin pre-impregnated polyester felt sleeve (referred to as a pre-preg) is used to reline municipal sewer lines. A pre-preg sleeve is one made from a fiberglass or similar fabric that has been previously impregnated with a catalyzed resin and then stored in freezing conditions to inhibit the curing exothermic reaction and to ensure an adequate shelf life. Fiberglass is not used as a pre-preg for sewer lines because it is considered a hazardous material. As used in a sewer line application, the process works as follows. The sleeve is put into a pre-cleaned sewer line that is temporarily not in use. The pre-preg sleeve is used as a liner which is capped off onto a manhole for access. The pre-preg sleeve actually is wrapped around a union in the sewer pipe so that an opening at only one end is created. As machinery pumps water into the open end of the pre-preg, it unfurls (inverts) with its interior being pushed out by the force of the water so as to adopt the form of the cavity of the sewer pipe. The process runs for a predetermined length such as from manhole to manhole. The water pressure inverts the liner to the diameter of the pipe, and the pressure keeps the pre-preg tube inflated. Once the sleeve is inflated, burners located externally, such as in a service truck, are turned on to heat water contained in a heat exchanger to a pre-determined temperature which is well above the ambient temperature. This heated water flows into the pipe in a closed loop causing the resin in the pre-preg sleeve to gel and then harden. A variation of the CIPP process is the Pulled in Place Pipe process. PIPP is a refinement of the initial CIPP inversion process. PIPP is a more exact term for this particular process that is found under the generic category of CIPP since the material is a cured in place product. The PIPP process uses a pre-preg structural fabric sleeve for the relining of various pipes, culverts and similar underground pipeline structures. The primary difference between PIPP and CIPP is that in the PIPP process the uninflated, pre-preg sleeve is winched, or pulled, into its proper position in the pipe. Then the same type of machinery is used in CIPP and PIPP to inflate the sleeve. Inversion methods require the flexibility inherent in a felt fabric, but felt fabric is not structural in itself, and its primary strength is from the resin or epoxy used. PIPP was introduced to facilitate a more structural sound pipe relining fabric. In PIPP the pulled in place sleeve is sealed at one end, and attached to truck mounted equipment at the other end. Then, heated water or steam is introduced into the sleeve which inflates and facilitates resin curing due to the elevated temperatures. Sometimes an inner bladder is used to compress the prepreg sleeve to the outer walls of the pipe to ensure proper fabric compression and attachment to the host pipe.

### SUMMARY

One exemplary embodiment describes a method for making and forming turbine blades. The method can include steps for determining stress loads on amore turbine blades; constructing one or more molds for components of the turbine blade in which a turbine-forming substance is disposed; applying a resin to an interior portion of the one or more molds; forming one or more partitions within the one or more molds; coupling the one or more molds; injecting the blade-forming substance into the coupled one or more molds; regulating the pressure in the coupled one or more molds; voiding any excess air or resin in the coupled one or more molds; and allowing the blade-forming substance injected into the coupled one or more molds to harden.

Another exemplary embodiment describes a system for making a turbine blade. The system can include a mold having a first portion and a second portion, wherein the first portion and second portion of the mold are coated with a release liquid; a primer disposed on the top portion and the bottom portion of the mold; one or more fabric sleeves inserted into the mold and corresponding to the one or more fabric partitions; a removal of the excess resin during an inflation process; a reinforcement layer disposed over any walls of the turbine blade; and a coupling that couples the first portion with the second portion of the mold.

### BRIEF DESCRIPTION OF THE DRAWINGS

Advantages of embodiments of the present invention will be apparent from the following detailed description of the exemplary embodiments thereof, which description should be considered in conjunction with the accompanying drawings in which like numerals indicate like elements, in which:

FIGS. 1A-1C provides exemplary perspective views of a wind turbine blade.

FIG. 2 illustrates an exemplary end view in perspective of a wind turbine blade.

FIG. 3A illustrates an exemplary hub to which wind turbine blades are connected as used in assembling a wind turbine structure.

FIG. 3B shows a cross-section of the exemplary hub of FIG. 3A along line A-A.

FIG. 4 shows an exemplary longitudinal cross-sectional view of the wind turbine blade of FIG. 1 constructed with multiple internal walls.

FIG. 5 depicts an exemplary latitudinal cross-sectional view of a wind turbine blade of FIG. 1 constructed with multiple internal walls.

FIG. 6 shows an exemplary embodiment of the integrated shear web(s) present in the prepreg liners.

FIG. 7 illustrates an example of a blade mold.

FIG. 8A shows an exemplary cross-sectional view of a wind turbine blade, illustrating a single spar wall created according to the invention.

FIG. 8B shows an exemplary cross-sectional view of the wind turbine blade of FIG. 8A along line A-A.

FIG. 8C shows an exemplary cross-sectional view of the wind turbine blade of FIG. 8A along line B-B.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

A system and method for custom constructing a one-piece wind turbine blade which may be used for the generation of commercial grade electric current is provided. The method can employ a modified cured-in-place pipe (CIPP) process for producing a custom composite of fiber reinforced polymer using, for example, thermoset or thermoplastic resins. This process can allow for production of a one-piece blade within a mold cavity, thereby avoiding potential issues that can arise when molding and joining two halves of a blade.

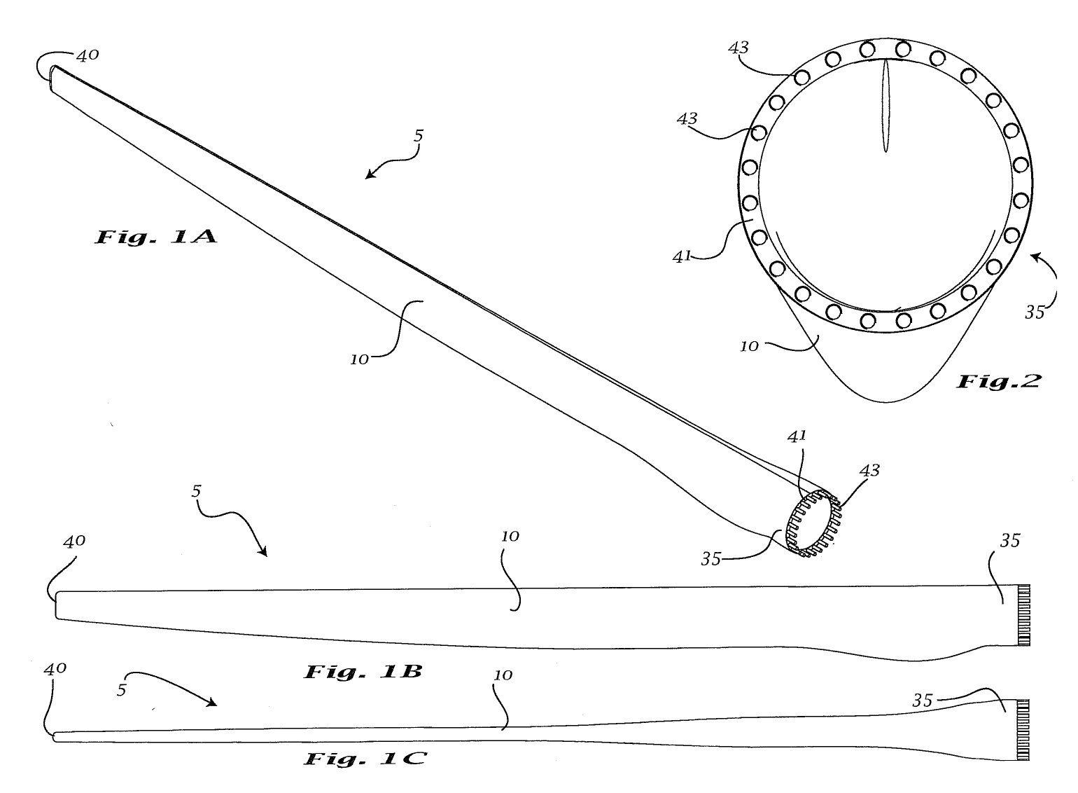

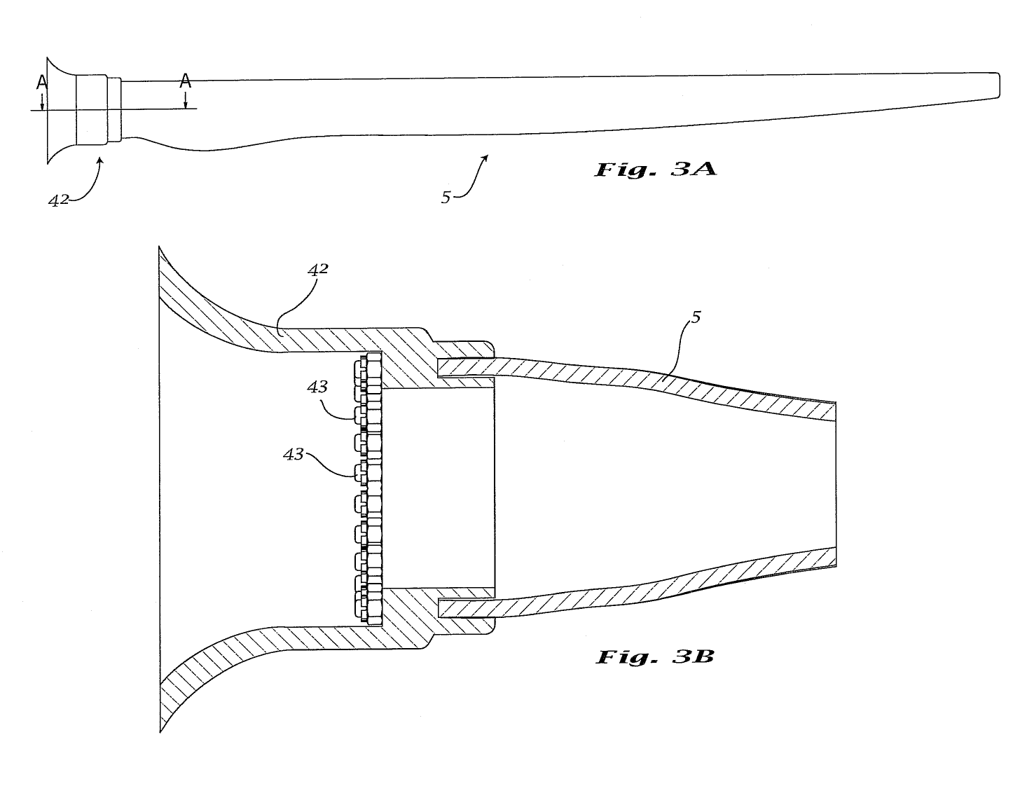

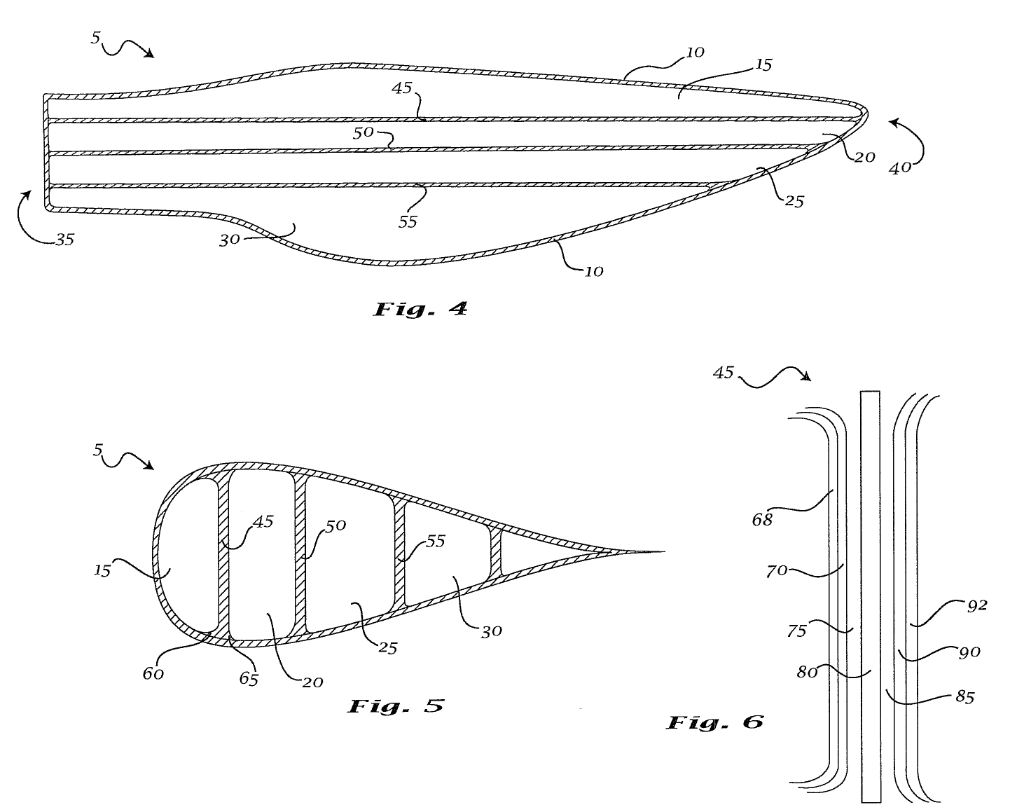

FIGS. 1A-C depict exemplary views of a typical wind turbine blade 5. A longitudinal cross-sectional view along line A-A of blade 5 constructed according to exemplary embodiments described herein appears in FIG. 2. Each blade 5 can have an outer skin 10 and two or more wind turbine blade shaped liner tubes, such as 15, 20, 25 and 30 (of FIG. 4), which can extend from root 35 of blade 5 to its tip 40. Root 35 of the wind turbine blade, shown in FIG. 2, may extend approximately six feet from the base of the structure, although the length may vary as desired. This portion of the wind turbine blade may be subject to intense forces during operation and therefore at least two plies of reinforcing fabric can be utilized with each ply oriented to a different direction, for example about 0, 90 or about −45 +45 degrees. These reinforcement fibers may then be laminated, i.e., resin impregnated, molded and cured to form the appropriate thickness of the composite, at that location in order to build up root section 35 at the very base, referred to as flange portion 41, of blade 5 to between approximately 6 and 8 inches in thickness. Flange portion 41 can be a portion of root section 35 at its base that connects to a hub 42 of the wind turbine structure when blade 5 is attached to a wind turbine structure. The blade may be held to hub 42, shown in FIGS. 3A-3B by a plurality of studs, the quantity and location of which can be uniquely engineered for each wind turbine structure to accommodate, for example, expected forces placed on the connection. The hardware used in the physical connection may be equal-length, stainless steel studs 43, though the studs may be made of any similar high strength steel alloy and the like and the lengths of the studs may vary. Studs 43 can be inserted into flange portion 41. Longer studs may be placed deeper into flange portion 41 of root section 35 providing more composite material between a barrel nut and hub 42 and resulting in a stronger connection. Again, determination of the lengths of the studs can be dependent on the expected loads on the wind turbine blade. The studs are threaded into a female thread of a barrel nut, place at a predetermined distance from the bottom edge of blade. These barrel nuts are pre-inserted into properly sized latitudinal bores originating from the interior surfaces of the blade, the studs once properly fixed in place in flange portion 41 of blade 5, may then be inserted through holes in hub 42, and then an appropriately sized nut or appropriate fastener can be placed on the male thread of the stud and tightened to a pre-determined amount of foot pounds of torque. This process can then be repeated for each stud until the wind turbine blade is completely bolted to hub 42. Studs 43 may be implanted in the root portion in a post-finishing process. Typical installation of a blade into hub 42 may involve drilling out of laminate material in root section 35 to a distance equal to the length of each stud.

In some further exemplary embodiments, a cross-bolt, which is the term for the stud and barrel nut assembly, may be used to form a connection between flange portion 41 of root section 35 of the composite wind turbine blade and a separate metallic flange in rotor hub 42. A barrel nut can be inserted into a radial bore hole drilled out of the composite material forming flange portion 41 of root section 35. A barrel nut may be formed of a steel cylinder with a female thread which is aligned with a longitudinal bore, which has been drilled to accept the bolt, starting at the mating flange of root portion 35. Furthermore, a flange of the rotor hub may abut against the lower edge of flange portion 41 of blade root section 35. The wind turbine blade root may then have through-hole fitting with a longitudinal bore. The through-hole and longitudinal bore can be aligned with each other so that a bolt or stud can be inserted into the through-hole and longitudinal bore. The bolt may include a male thread fitting designed to fasten with the female thread of the barrel nut. The bolt can be threaded into the female thread of the barrel nut after which the stud is tightened so that a cross-bolt connection is established. A rotor blade may then be affixed to rotor hub 42. This process can be repeated until a desired number of cross bolt connections have been completed. The exact dimensions of the bolts and barrel nuts used may be varied as desired; for example they may be dependent on the loads to which blade 5 may be expected to be subjected.

In an alternative exemplary embodiment, a camlock could be used to interconnect flange portion 41 to hub 42. Then on the interior of the finished blade, a second cavity can be drilled out starting at the end of the drilled out first cavity for the stud. This drilling may be accomplished from an interior portion of the blade. A camlocking device can be placed in the second cavity which, after a stud is inserted therein, may be turned and grabs the protruding head of the stud so as to lock the stud into the camlock. This procedure can be repeated for each location where a stud may be desired. In practice, the camlocks may be laminated over with any number of plies of fabric, for example three or more plies, which may block out moisture or otherwise provide for a seal. The camlock system can allow for the removal and replacement of studs as needed or specified during the service life of the wind turbine. Other alternative methods of hardware attachment known in the art may also be used. Stainless steel or other non-corrosive, high strength metallic alloy hardware may also be used for the studs and camlocking.

The wall of any tube, for example tubes 15, 20, 25 and 30, may be formed of structural fabric, aramid, E-glass, carbon or the like, oriented in directions of about 0+−45+−23 and 90 degree fabric, or combinations thereof, about 3 or more plies on single direction fabric, i.e., uni-directional fabric on each ply. However, in the construction of a wind turbine blade, a majority of the fabric could be oriented in the about 0 degree direction, i.e., longitudinally with the wind turbine blade. These plies can be manufactured in the CIPP liner technique of fabric/polyester felt/fabric, though they may be modified for this present use of manufacturing a wind turbine blade by including an outermost layer of either chopped e-glass strand mat or continuous e-glass filament matt.

In one example, a continuous filament mat may be used as it is both compatible with infusion for wet out and stronger. Also, in the CIPP liner polyester felt is the core material of the fabric, while in this application felt might serve to increase resin weight without adding any tension strength so that a structural fabric is substituted for the felt. The tubular sleeves, shaped in the form of a wind turbine blade, may be made from woven glass fiber, felt or multi-axial fabric glass-fiber, braided fiberglass fabric and the like, although multi-axial fiberglass, or a hybrid combination of e- or s-glass with aramid or carbon fibers may be utilized. There are three general types of fiberglass fabrics: woven, non-woven (multi-axial), continuous filament and chopped strand. In this process strength and weight may be considered. An example of a woven material would be an about 0-90 degrees woven fabric. Fabrics can also have different architecture that imparts some specific characteristics, such as drapability. Weaving types may be plain: each warp fiber (0 degree {machine direction}) passes under and over each weft (90 degree) fiber. An example of a woven fiberglass fabric would be BGF style 120 which has the following specifications: Glass Composition: E Glass, Warp Yarn: D450, ½ Filling Yarn (weft): D450 ½, Yarn Count Warp×Fill/inch: 60×58, Weave Pattern: 4HS, Tensile Strength (W×F, lbs/inch): 135×124, Weight Oz/sq yard: 3.16, Thickness mils: 3.5, Finish: 627, compatible with polyester and vinyl resins. An example of a non-woven multi-axial fabric is Vector Ply Corp's 64TZ VPLY fabric from its Vector Wind Line which has the following specifications: Fiber Type: E-glass, Architecture: 0/+45/−45 tri-axial, Dry Thickness: 0.66 mm, Total weight 18.94 oz/sq yd. Chopped strand mat fabric is available and may be utilized in some exemplary embodiments as the outermost layer of the reinforcement schedule. Due to their infusion capabilities, high strength and low weight properties, multi-axial fabrics may be utilized as types of fabric in the exemplary processes described herein. Furthermore non-woven multi-axial fabrics used in these exemplary embodiments may not have reduced compression properties as they are not crimped as the result of the over/under construction used in the weaving process. The separate plies of non-woven multi-axial fabrics can be stitched together with a polyester thread or rely on a sprayed on adhesive to join the plies. Although many fiberglass fabrics, including the example cited above, are called E-glass fiber, S-glass fabric may be a stronger fiberglass having other properties similar to E-glass and can also be used in the exemplary processes and systems described herein. Alternative fabric choices include, but are not limited to, carbon fiber, polyacrylnitrile, Kevlar (aramid), polyester and the like. For example, carbon fiber may be a desirable alternative fabric material due to its high strength and light weight. Similarly, a glass/carbon fiber hybrid fabric could be used. Drapability can be dependent on fabric architecture so that finer, more densely woven or stitched fabrics are more drapable.

Shaping of each of the wind turbine blade shaped liner tubes, such as 15, 20, 25 and 30, in some exemplary embodiments can be performed to avoid or prevent stretching and/or wrinkling which could have detrimental and unexpected effects on the stability, strength and durability of the resulting structure in which the liner tubes may be employed. The liner fabric can be draped over a mandrel in the shape of a wind turbine blade 5 after which excess fabric can be removed and a bonding line established. The resulting sleeve can be stored to await eventual resin impregnation, as described in more detail below. Alternatively, the liner fabric can be cut to a template matching known dimensions of a wind turbine blade which has been laid out flat and symmetrical in the longitudinal direction. Bonding could occur on either the trailing edge of the liner to minimize waste or on the leading edge to provide overlap and extra strength together with protection against erosion. In another variation of the fabric lay up, multiple plies, for example two or more two plies of structural fabric, can be stitched together, and a template may be used to cut out a desired shape. Then, the stitched fabric can be wound over a mandrel, the mandrel effectively being rolled up into the fabric. Wound two-ply fabric can thus effectively become a four ply fabric and could increase further as desired or if the size of the fabric allows for additional windings over the mandrel. In this method, additional fabric reinforcements could be applied specifically to root section 35 and/or flange portion 41. The overall shape of the fabric while in flat sheet form could be in the shape of a wedge with an inwardly curving circular edge at the area designed for root section 35 and gradually tapering down to the area designed for tip 40. At completion of the winding, the fabric may be lightly wrapped with a thread or other fiber to prevent unwanted unwrapping of the fabric, and the mandrel can then be then removed and replaced by a bladder, as shown in further exemplary embodiments. An inflated bladder could alternatively be used as the mandrel. In yet another exemplary embodiment the wind turbine shaped liner tube could be manufactured in the manner of a braided or stitched sock, where the structural fabric is fabricated in a roughly tubular manner, thereby eliminating a bonding seam along the longitudinal axis. The fabric may be trimmed and bonded at the tip end of the liner in order to close opening found at the tip end. This sock type of fabric in a braided configuration would have the necessary stretch capability which would allow for the conforming to the internal mold dimensions when inflated.

In some exemplary embodiments, using this method to form an integral shear web could include cutting the fabric template as described above, but the two inner layers could have enough extra material to create a shear web. The two inner layers could have the extra material pulled together to create a double layered pleat, at an approximately 90 degree angle to the fabric, in the fabric reinforcements. The pleat could be stitched, fastened or adhesive bonded together to hold its shape. This pleat could transverse the entire length of the blade. In this method a specially shaped mandrel or inflated bladder, as desired, can then be used to accommodate the pleat by having a space in the mandrel or bladder to hold the pleat between the two sections of the mandrel or bladder, similar to the “fingers of a glove” as described above. This void in the design of the mandrel or bladder may allow for the proper angle of pleat to swept surfaces is maintained, and also maintain the pleat from wrinkling. Then, when the fabric begins to be wound, the pleat can be rolled over onto the opposite face of the fabric. Thereafter, when the winding is complete, but the mandrel or bladder is still within the wound dry fabric, a stitching or other fastening or adhesion could be applied to integrate the pleat into the inner side of the opposite blade surface. Alternatively the stitching, fastening or adhesion of the pleat could also occur after the mandrel or bladder is removed from the structural fabric. This fastening of the pleat could be accomplished by stitching a polyester or similar material thread into the creased portion of the pleat, linking it to the reinforcing fabric. This winding method of fabric lay-up may only be compatible with the non-integrated bladder inflation method of forming blade 5, i.e., the use of a silicone bladder, which could be removed after inflation and curing. Various methods of bonding could also be used including, but not limited to, heat bonding with certain fabrics, stitching together using a pliable high strength nylon or similar polymer which is compatible with the resin or epoxy matrix used in the laminate and capable of withstanding exothermic temperatures including above ambient or elevated cure temperatures.

In a further exemplary embodiment, and now referring to exemplary FIGS. 4-6, the walls of tubes 15, 20, 25 and 30, including their outer layers, may be pre-impregnated (pre-pregged), or wet out, with one or more thermoset or thermoplastic resins. In one exemplary embodiment, the matrix material may be a thermosetting resin. For example, thermosetting resins such as epoxy resin, epoxy novalacs, polyesters, vinylesters, polyimides (of condensation and addition types), phenolic resins, and bismaleimides are usable as matrix materials. In use, a particular resin can be selected according to the specific technical purpose the fiber reinforced matrix is applied to. For example the resin system can be selected with respect to the particular fiber reinforcement for producing a fiber and resin composite part with the desired environmental and mechanical properties. One exemplary polyester resin could be of the isophthalic variety, for example, due its water resistance characteristics, although orthphtalic (general purpose) variety and the like could be also used. For example, a vinyl ester resin may be used for its chemically resistant characteristics and may have some higher strength properties. Epoxy resin may also have a high structural strength with excellent water resistance. Thus, an exemplary resin system for a wind turbine blade is epoxy resin. In practice, the resin or epoxy resin to be used in the construction of the laminate can be degassed under vacuum after the mixing in of a catalyst, or hardener as in the case of an epoxy, into the resin. The purpose of the degassing can be to remove all entrapped air from the liquid resin. If they are not removed, such air pockets produce voids in the finished laminate which can reduce the strength of the material where such voids develop. Regardless of which type of thermoset resin is used, a catalyst, such as a ketone peroxide, like Luperox® DDM-9 which is a registered trademark of Arkema, Inc., or, in the case of an epoxy resin, a hardener such as Pro Set Inc. 224 hardener, may be added to the resin to initiate an exothermic reaction. Resin systems may also use a photoiniator type catalyst, where the resin is cured by introducing ultra-violet light in contact with the resin system. The introduction of ultra-violet light within the mold may be sufficient to adequately initiate the exothermic crosslinking reaction resulting in a cured laminate. Such photoinitiators are a type of non peroxide catalyst and are commercially available from companies such as Sunrez. Inc. An advantage of ultraviolet light curing would be a quick cure time, that is unaffected by temperature and humidity levels. Ultraviolet light sources such as UV lamps or UV emitting LED's are commercially available and could be integrated into the inner mold surfaces in order to introduce sufficient ultra-violet light to promote resin curing. If the ultra-violet curing method is used the above described systems for applying internal mold pressures through the use of a removable or integrated bladder would be applied until full curing has been completed. Thermoplastic resins may also be employed in which case the introduction of heat is sufficient to initiate liquefaction of the pre-impregnated resin followed by a controlled cooling period to cure the thermoplastic resin. One potential side effect using thermoplastic resin is its potential for recycling. The process of resin impregnation of liner tubes is well-known in the CIPP industry. For example, vacuum pressure can be used to resin-impregnate the dry fibers of a liner. This process is referred to as vacuum assisted resin transfer molding (VARTM). In this process, a desired amount of properly catalyzed and degassed resin or epoxy resin with hardener can be pumped into a vacuum bag having roughly the dimensions of the wind turbine blade, e.g. blade 5. Such a bag can be made from nylon although other fabrics may also be used, the vacuum bag may then be placed over the dry structural fabrics and sealed in order for the vacuum to be introduced. After a vacuum is applied to evacuate any air trapped in the vacuum bag and to compress the resin matrix into the fabrics so as to wet out the liner tube into which a bladder has been previously inserted, the liner tube could be fed into at least a two roller system conveyor, having rollers, for example, on top and bottom. The fabric can be fed through the rollers, while still under vacuum, and the rollers can force the resin further into the fabric and distribute it evenly throughout the fibers. This arrangement is typical of wet out set ups in the CIPP industry. Average space between rollers can be slightly smaller than the overall thickness of the fabric sleeve, so as to force resin into the fabric but not exert so much pressure that the fabric would be distorted. Where large diameter liners may be impregnated with resin, as may be the case for wind turbine blades, mobile wet out machinery can used. Using such machinery on-site at the point of assembly and erection of the wind turbine can allow for longer pot life and less reliance on the need for refrigeration since, if the liner is impregnated elsewhere, it might be refrigerated to prevent curing of the resin. An alternative exemplary wet out method may be to use the resin transfer method to infuse the fabric with resin before laying it into the mold. In this process a desired amount of resin can be pumped into a vacuum bag and placed over the fabric reinforcements, then a vacuum can be applied at the opposite, tip end, of the bag. The vacuum can pull the resin through the fabric reinforcements. Any excess resin is caught in a vacuum chamber, which can prevent damaging resin infiltration into the vacuum pump being used.

The total number of tubes employed in a particular blade depends on the anticipated stresses to be placed on blade 5. Although the blade could be a completely hollow structure, it may be desirable to use a minimum of two tubes, each of which can be separated from the other by an integrally sewn in fabric wall which forms the shear web and which, in the case of a single fabric wall shear web, could bisect the blade longitudinally, and is connected or sewn or otherwise bonded to the liner's upper and lower swept surfaces. The thickness of the fabric wall shear web could range from about 0.013 inches of dry fabric, which would be a single ply of 0 degree fabric to an upper range of approximately one inch of dry fabric comprised of multiple layers of structural fabric. The fabric wall becomes structural as the epoxy resin or similar thermoset resin with which it is impregnated cures. Proper positioning of the fabric wall can result from the use of one or more bladders.

The bladder can be shaped specifically to fit the number of cavities resulting from the number of fabric walls 80. The bladder may originate at, and can be coupled to the vented end cap and can diverge into two or more sections that fit into each side around each fabric wall 80, so that, when inflated, the bladders may press not only on the outermost layers of the blade, but also exert pressure on each fabric wall 80. The general form of the bladder can be likened to a glove, the space between the “fingers of the glove” indicating the space allowed for each fabric wall 80.

In another exemplary embodiment, two or more separate bladders can be used, each one fitting one of the two, or more sections segmented by the presence of fabric wall 80 which can be inflated with water, steam, any other liquid or air or any other gas and which then hold the fabric wall in position until curing is complete.

In yet another exemplary embodiment, two or more or pre-preg liners, such as those constructed from, but not limited to the laminated schedule of, fiber/felt/fiber/polyurethane, can be inserted into a liner which includes the sewn-in-place fabric wall 80 of the wind turbine blade within the mold. Then, the two (or more if applicable) pre-preg liners can be inflated using the integral polyurethane inner layer as an integrated bladder. These inner liners could be shaped for the specific regions where they are intended to be placed and inflated.

Thus, in this exemplary embodiment, when the bladders are removed, the liners can remain in place, having been bonded to the interior surfaces of the blade. Alternatively, in the secondary inflation process, when pressure is released from the liners, the integral polyurethane layer and fibers can be left in place while curing is complete.

Fabric walls 80, also referred to as internal center spars or shear webs, produced by these methods could then become an integral piece of wind turbine blade 5. This structure imparts significant strength to the wind turbine blade with regard to both flexural and torsional stresses. Wall 80 can act as a shear web in an I-beam, providing support to the two swept surfaces that, depending on the load, may either be in compression or tension. The shear web helps mitigate theses stresses, thereby resulting in a stronger structure, than a hollow structure.

In the event where a hollow blade is used without structural fabric walls, a network of three-dimensional fiber cages comprising approximately fifty hoops may be utilized. The hoops can be placed on the internal surfaces on the wind turbine blade in a perpendicular attitude to the overall length of the blade. These hoops can be constructed of structural fiber bundles, such as e-glass, aramid, carbon fibers or the like. Alternatively, the hoops could be constructed of three dimensional fabric strips, such as the kind manufactured by 3Tex, Inc of Cary, N.C. The hoops may be approximately two inches in width, and can be bonded together at the longitudinal liner bonding line. The swept surfaces (i.e., the top and bottom of the blade wing) can be stiff, as desired. Increasing the number of tubes can increase the rigidity of those surfaces due to an increased number of flanges, but may result in an increase in weight. The precise number of tubes needed in a particular application can depend on an engineered balance between maximum strength and minimum weight.

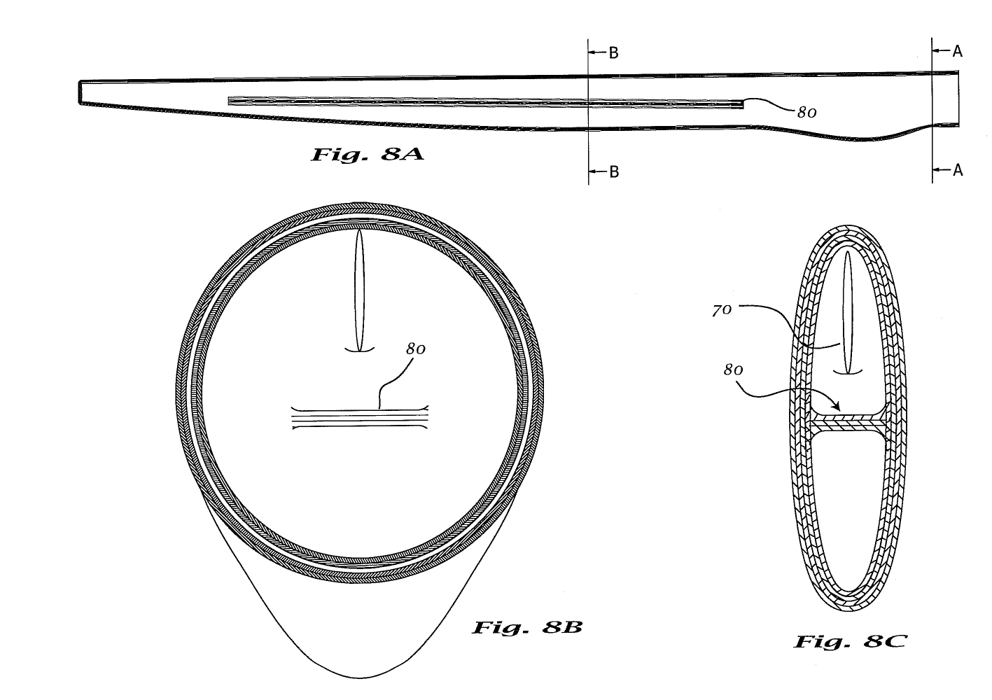

FIG. 5 shows an exemplary latitudinal cross-sectional view of blade 5. Spar walls 45, 50 and 55, as well as supporting flanges 60 and 65, can form part of an integrated structural web extending longitudinally throughout blade 5. FIG. 6 displays an exemplary blown-up view of a latitudinal cross-section of spar wall 45. In one exemplary embodiment, each spar wall can be layered and may be made of a first polyurethane barrier coating 68, an inner wall 70, a first resin layer 75, a wall partition core layer fabric 80, a second resin layer 85, an outer wall 90 and a second polyurethane barrier coating 92. Exemplary embodiments may further be shown in FIGS. 8A-8C and describing inner wall 70 and partition 80, where FIG. 8A may be an exemplary cross-sectional view of a wind turbine blade, illustrating a single spar wall created, FIG. 8B may shown an exemplary cross-sectional view of the wind turbine blade of FIG. 8A along line A-A and FIG. 8C may show an exemplary cross-sectional view of the wind turbine blade of FIG. 8A along line B-B.

Laminated thicknesses of the fabrics can range from a single unidirectional low weight fabric having a thickness of about 0.019 inches to a single quadraxial heavier weight fabric having a laminated thickness of about 0.076 inches. Each fabric wall 80 can contain a minimum of one multiaxial stitched or woven structural fabric ranging in thickness from about 0.028 inches to about 0.049 inches and a maximum of about eight plies of a quadriaxial fabric. In the exemplary embodiment more fully explained below, the resin pre-impregnated liner, shaped to the specific sectional dimensions of a wind turbine blade, or other roughly tubular shaped mold dimensions can have at least one integrally sewn-in-place fabric partition wall, which, in the case of one wall, may equally bisects the blade. The process can employ either a single pre-pregged liner having an interior-facing polyurethane layer which is in direct contact with a heat transfer liquid or steam or a pre-pregged liner into which at least one or more properly shaped silicone or other similar heat and chemical-resistant elastomer type bladders are inserted for receiving a heat transfer liquid or steam. Each bladder may then expand into its respective, predesigned shape within the mold. Regardless of the process used, the resulting structure ultimately can form blade 5 along with at least one integrally formed interior center spar wall, also referred to as a shear web. As a result, when the process described above is used, the outermost liner which is in the shape of hollow wind turbine blade, can remain as the outermost layer of blade 5 while the injection of heater material can press the bladder(s) to the inner dimensions of the blade liner abutting the sewn-in-place fabric partition. In the second process described above, the bladders are expanded and then maintained under pressure in the range of between approximately 1 psi and approximately 50 psi, regardless of whether gas or liquid is used, until curing is complete after which the bladders are removed leaving fabric wall 80, the center spar(s), or shear web, in place. The first process may employ the use of more material than the second process since the internal liners are made up, respectively, of layers fabric/felt/fabric/polyurethane (as denoted from outer to inner layers), that would bond to the interior dimensions of the outer most layer. However, in both process, each of the spar walls may be constructed similarly.

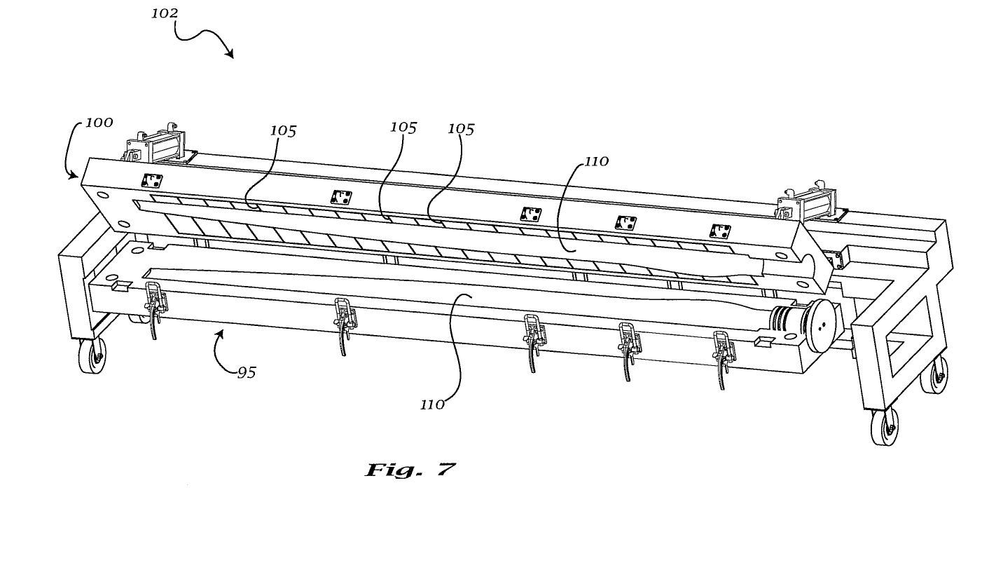

The process of forming a wind turbine blade or other structure as disclosed herein can begin with engineering the shape of the desired blade and ascertaining the resulting stresses and loads to which various part of the blade will be subjected. Thereafter, construction of a corresponding mold, for example a two-piece mold with a top section and a bottom section, for the desired end product, in this case a wind turbine blade. An example of a blade mold 102 lower blade mold 95 and an upper blade mold 100 is illustrated in exemplary FIG. 7. Both portions of the blade mold 102 can include a network of ports 105 used to vent air and excess resin as described below. Prior to initiating the actual blade creation process, the inner surfaces of the mold cavity 110 may first be sealed and coated with a mold release liquid or wax. Then, those same surfaces may be sprayed with a paint type primer which forms outer skin 10 of the blade. The primer can be a resin formulation, typically applied with gel coat equipment. Both the sealer and the primer may be reapplied for each new wind turbine blade produced. Alternatively, the mold could be multi-sectional to aid in mold preparation and the application of release and gel coatings. Based on engineering considerations, as discussed previously, at least one structural support wall or spar may be desired in the end product. Where support walls or spars are necessary, a multi-axial fabric, such as a stitched triaxial such as a +45, 0, −45 degree fabric, or a braided pattern may be used, the orientation of the fibers of which depend on accommodating the tension loads and stresses to which the blade will be exposed as a result of its design as well as on the blade's geometry and relative ease of processing with a particular fabric. For example, a two ply 0-90 degree and 0-45 degree bi-axial fabric or a quadri-axial fabric having four layers with fibers running in a 0, +45, −45 and +90 degree directions may be used. This fabric is resin-impregnated and multi-axial. Each wall partition 80 can stretch from the top of the mold to the bottom of the mold (perpendicular to the wide blade surfaces in the case of a wind turbine blade) and extends from root 35 to tip 40 of blade 5.

Various types of fabrics can be used, as described previously, although non-woven multi-axial fiberglass fabrics may be desired. An S-glass fiber fabric or aramid may be a choice for the structural fabric because of its processibilty, and its ability to be conformed to the tight radius found in the blade geometry. An S-glass fiber can also be used in conjunction with E-glass, aramid and carbon fibers. Each such fiber could be applied to portions of the blade where the characteristics of that fiber are most beneficial. Carbon fiber may be the stiffest and has the highest tensile strength, but may not be resistant to impact shock. Carbon can be used in a hybrid fabric to give some stiffness, is in the swept surfaces, while imparting its very low weight. Aramid is an aromatic nylon that is hygroscopic in that it will absorb water. This characteristic can lead to osmotic blistering which is both a cosmetic defect and can lead to delaminating, a serious structural problem. Aramid however is used in composite aircraft and is easily processed, as well as being high in tensile and impact strength. Aramid fibers may be best used in the interior surfaces of a wind turbine blade as they are less susceptible to water exposure in that location. S-glass is a higher strength glass fiber, but is more costly than E-glass. E-glass is the low cost material of choice of the composites industry. It has good processing and strength characteristics but does weigh more than carbon or aramid. Windstrand®, a registered trademark of OCV Intellectual Capital, is a type of E-glass that is manufactured by Owens Corning, for the wind energy market. Windstrand® imparts higher tensile strength than standard E-glass. In summary, E-glass fibers may best be used in exterior surface applications where they can be mixed with carbon fibers in a hybrid fabric for added strength. Aramid, for example, may be used in the inner-most layers of the blade, away from any possible moisture intrusion. After testing individual blade designs, high stress areas can be identified and can be reinforced with carbon fibers in the laminate to avoid the weight addition accompanying the use of extra plies of E-glass. Additionally, if using carbon, an epoxy resin can be used, as carbon may be pre-treated (finish applied during its manufacture) for epoxies.

Depending on the number of walls desired by the design of the blade, in the secondary integrated bladder process, a separate tubular sleeve or bag, such as 15, 20, 25 and 30, can be constructed for each side of each wall from a fabric, such as a non-woven, multi-axial fiberglass fabric which sleeve corresponds in volume to the space which it will occupy between either the outer skin of blade 5 and a single wall partition fabric 80 or, in the case of more than one wall, between different wall partition fabrics 80 and the outer skin of blade 5. The sleeves may have one or more of woven glass fiber, carbon fiber, aramid, cellulose, polyester felt and may use multi-axial fabric or braided fiberglass, although multi-axial fiberglass fabric may be desired. Each sleeve is pre-impregnated and saturated with a thermoset or thermoplastic resin which may be one or more of a polyester, vinyl ester or epoxy resin and may, in addition, be laminated during a manufacturing process after the construction of the fabric but prior to resin impregnation in one or more areas with a resin impermeable protective film such as, but not limited to, polyurethane, polyethylene or PET plastic film which may exhibit elastic properties to accommodate slight expansion as the liner is forced into all the inner mold dimensions. In terms of the spar wall 80 cross-section as depicted in FIG. 6, the sleeve material corresponds to inner wall 70 and outer wall 90, the resin corresponds to resin layers 75 and 85 and the protective film corresponds to barrier coatings 68 and 92. Each sleeve conforms to the geometry of the wind turbine blade so that it may fill all areas of the mold cavity for which it is designed. Each sleeve may be thick and robust at root 35 but may taper down to a vanishing point at tip 40. Sleeves could also be constructed from braided e-glass fabrics such as a +45, −45, available from A & P technologies Ohio. Braids can also be of a hybrid construction, intermingling e-glass with carbon and or aramid. Additionally, the blade itself could possibly be made of one or more plies of braid, then sleeves could be inserted and a bladder inflated in the secondary curing process to construct the shear web.

Regardless of which blade formation process is used, the top and bottom sections of the mold, assuming a two-piece mold is being used, can be joined once the pre-pregged liner is set in place. After the bladder within each tubular sleeve has been attached to a one-piece, vented endcap, the endcap itself can be attached to a source of gas, water and/or heat transfer liquid such as oil or glycol. The desired substance or substances may then be introduced simultaneously into all tubes to inflate each bladder sleeve to gradually fill the cavity for which that sleeve has been designed. Once all of the tubes are fully inflated the temperature of the substance being injected into each tube can be gradually increased beyond the ambient temperature to the point where an exothermic reaction is initiated so as to cure the respective thermoset or thermoplastic resin with which the tubes have been pre-impregnated.

To regulate the pressure a manifold can be used. The manifold can have four ports: a supply from either air, liquid or steam, an outlet with a differential pressure valve (to maintain pressure in the bladder(s) in case of an unexpected pressure drop from the supply, a pressure gauge to monitor pressures and a regulator/bleeder to control the amount of pressure fed to the bladders. The manifold can be manufactured out of aluminum, and can have the four ports intersecting internally forming a cross shape. The pressure gauge can be attached to the top most port, the supply to the right hand port, a regulator attached to the bottom port, and the outlet attached to the left hand port, where the differential pressure valve is attached. Typically, the curing temperature is between about 200° F. and about 300° F., but is not limited to this temperature range. For example, an elevated cure temperature can be maintained throughout curing and even thereafter in order to obtain a stronger composite part due to more complete crosslinking within the resin system. Steam may be introduced as an alternative to a heated liquid, depending on the desired temperature. In the case of curing by means of introduction of steam, however, the temperature increase can be rapid. It is also possible to use a resin which cures at ambient temperature. However, this approach may have the disadvantage that it results in a shortened working time since curing starts as soon as the liner is impregnated with a catalyzed resin. A relatively constant pressure, between approximately 1 psi and approximately 50 psi, can be maintained in the sleeve so that the curing process results in the formation of consistent, even walls as the resin cures. The substance introduced into each sleeve may be circulated or exchanged over time to maintain a constant temperature or to vary the temperature, as desired. Note that all resin impregnated sleeves may be stored prior to insertion into a mold in conditions which inhibit the initiation of an exothermic reaction. Thus, although the temperature need not be freezing, it may have to be below the ambient temperature of the atmospheric air where the blade will be manufactured.

The function of integrated wall partition fabric 80 can be to separate the pre-impregnated tubes as they are inflated using either of the aforementioned processes and to provide structural strength in the resulting blade 5. In response to inflation of the tubes, the fibers in the liner can be compressed thereby forcing out air so as to eliminate air pockets and also pressing out any excess resin. The resulting air and excess resin may be voided through the network of ports 105 lining the mating surface between the two mold halves. In the event a one compartment, hollow blade method with three-dimensional fabric hoops, as described above, is used, a reinforcing fabric such as 3 Tex (or carbon fiber or aramid unidirectional tows) may be used to form the hoops and provide structural support. In this case, as the heated material is injected, the resin with which the hoops and liner have been pre-impregnated can be similarly compressed and air pockets and excess resin are also voided through the mold ports. In processes where wall partition fabric 80 are used, the inflation pressure applied to adjacent sleeves (bladders) can be controlled and balanced to ensure that equal pressure is applied to both sides of each wall partition fabric 80 thereby preventing bowing of any wall partition fabric 80 in either direction. Consequently, the resin pre-impregnated sleeves can harden in place to the dimensions of the mold. The result may be a structurally strong, one-piece, webbed structure including walls perpendicular to the blade surfaces with associated flanges. To assist in proper liner placement and inflation with the mold, a series of indexing tabs, connected to the outer layer of the liner, could also be affixed to the mold. These tabs could project from the outer layer and may be spaced evenly around the outer edge of the liner at the center line of the liner in the mold. These tabs could be fixed to the lower mold and clamped in place so as to keep the liner from shifting in the mold while under inflation pressures.

When the process used employs an inner sleeve, or bladder, this bladder can be made from a non-porous fabric, resin impermeable substance, such as silicon, while the outer sleeve is slightly larger and is made from a resin-porous fabric. The inner sleeve can be sized so that when properly inflated it fits within the outer sleeve and exerts pressure on the outer sleeve thereby increasing the fiber to resin ratio so that excess resin is pushed out of the fabric in the outer sleeve due to the pressure which is being exerted by the inner sleeve. The inner sleeve may also be inserted into the outer sleeve fabric prior to curing of the outer sleeve to form a wind turbine blade shape, as described above. In order to prevent fabric stretching or distortion, the outer sleeve with the inner sleeve may be laid into an opened mold, as desired. After being properly positioned in the mold, regardless of whether the single liner or liner-with-bladder method are used, a vented endcap can be inserted which is designed to accommodate the required number of bladders. The endcap is typically made out of aluminum, although it is not restricted to that material and any other desired material may be utilized. The side of the plug facing root section 35 of the wind turbine blade can be grooved to accept the end of one or more bladders. In the case of one bladder, one vented end cap with a single circular groove and one inlet and one outlet port could be used. If two separate bladders were to be used, the endcap could be ported with an inlet and outlet for each bladder, and could be grooved in the middle to affix two bladders, i.e., instead of a single circular section there would be two half circles with a space in between so that the two bladders could connect to the respective area adjacent to and without pinching each other. A larger number of bladders could utilize similar modifications to the endcap design. The mold is then closed, also exerting pressure on the plug and bladder, and making a seal. Once the mold is closed, inflation can begin. The plug described may have at least two ports, one inlet and one outlet. The inlet port can allow either gas, steam, or a heat transfer liquid to enter the bladder. The outlet can have a regulator and bleeder attached, in order to maintain correct inflation pressures. As pressure is increased, through either air steam or water, the bladder can begin to expand the outer sleeve into the mold cavity. When the mold cavity is filled with the outer liner, bladder pressure continues to increase thereby compressing the structural fabric reinforcement layers and forcing out air and excess resin through venting ports in the mold, as mentioned above. In the case of ambient cure, air inflation could be used. In the case of above-ambient cures, the heat from the steam would initiate cross-linking. If a heat transfer liquid is used, the liquid could be re-circulated into and out of the bladder by way of an extension pipe or hose running from the plug that would extend inside the bladder from the rear thereof towards the tip of blade 5, extending over about 90% of its overall length. The pipe can act as a port for the introduction of the hot water or other liquid into the bladder. The pressure with which the liquid is injected into the pipe can ensure adequate circulation by forcing cooler liquid to the rear of the bladder where it could exit through an outlet in the vented endcap and travel back to the heat exchanger thereby ensuring a continual flow of heated liquid through the mold. Apparatuses for providing hot liquids or steam are generally separately truck mounted, as is the case with the existing CIPP machinery, but could be integrated into the mold structure as a complete self contained molding unit.

The described system and method further provide the potential for a completely mobile production facility. The pre-impregnated sleeves can be stored on a first refrigerated truck, while a second truck provides sleeve inflation facilities. A diesel tanker can supply fuel necessary to heat the required water otherwise carried by a water tanker, and a last vehicle can carry blade molds.

The system and processes described are not limited to use in wind turbine blades. They can also be applied to other mold processes where strength, weight, speed of production and assembly and/or product transportation difficulties are issues and where various diameters, lengths and shapes are desired for the processing of multi-celled composite structures. Regardless of the application, the described system and method radically reduce labor and equipment costs associated with mold-based processes, especially those involving large, bulky components.

Use of the system and process described herein can result in a simplified wind turbine blade construction method that replaces the traditional lay-up of dry fabric and vacuum infusion process. In addition, the system and method described herein provide greater automation, increased production speed, greater consistency in the laminate reinforcement fabric used to manufacture the wind turbine blade, greater strength due to the one-piece wind turbine blade that is created and reduction in weight of the resulting blade. Other benefits can include reduced cycle time and reduction in cost and amount of materials needed. Since the production process can use truck mounted equipment to infuse fabrics in the mold cavity, the risk of damage and the expense of transporting wind turbine blades from manufacturing point to assembly site can be reduced or eliminated.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of making a turbine blade, comprising:
determining stress loads on amore turbine blades;
constructing one or more molds for components of the turbine blade in which a turbine-forming substance is disposed;
applying a resin to an interior portion of the one or more molds;
forming one or more partitions within the one or more molds;
coupling the one or more molds;
injecting the blade-forming substance into the coupled one or more molds;
regulating the pressure in the coupled one or more molds;
voiding any excess air or resin in the coupled one or more molds; and
allowing the blade-forming substance injected into the coupled one or more molds to harden.

2. The method of claim 1, further comprising coupling the blade to a turbine.

3. The method of claim 1, wherein the one or more molds include a top portion and a bottom portion.

4. The method of claim 1, wherein the blade-forming substance is injected into the mold at a predetermined pressure.

5. The method of claim 5, further comprising forming a predetermined number of liner tubes in the turbine blade.

6. The method of claim 5, further comprising impregnating the predetermined number of liner tubes with a resin.

7. A system for making a turbine blade, comprising:
a mold having a first portion and a second portion, wherein the first portion and second portion of the mold are coated with a release liquid;
a primer disposed on the top portion and the bottom portion of the mold;
one or more fabric sleeves inserted into the mold and corresponding to the one or more fabric partitions;
a removal of the excess resin during an inflation process;
a reinforcement layer disposed over any walls of the turbine blade; and
a coupling that couples the first portion with the second portion of the mold.

8. The system of claim 7, wherein the bladder has two or more chambers that fit two or more cavities in fabric walls.

9. The system of claim 8, wherein the fabric walls are impregnated with a resin to form structural support walls.

10. The system of claim 7, wherein the release liquid is one of a mold release liquid and a wax.

11. The system of claim 7, further comprising a retracting conveyor belt that lays the resin impregnated liner in the mold.

12. The system of claim 7, wherein the fabric liner is a pre-impregnated with a thermoset or thermoplastic resin.

13. The system of claim 7, wherein the at least one or more fabric sleeves are expanded using one of air, a heat transfer liquid and a heat transfer steam supplied through a manifold until curing is complete.

14. The system of claim 13, wherein the manifold includes one of an air, water and steam pressure-supplying port, a differential pressure valve, a pressure gauge and a regulator.

15. The system of claim 7, wherein the primer is a resin and forms an outermost layer of the turbine blade.

16. The system of claim 7, wherein the mold includes a predetermined number of ports that vent air and excess resin.

17. The system of claim 7, further comprising a curing of the resin between about 200 degrees Fahrenheit and about 300 degrees Fahrenheit.

18. The system of claim 7, further comprising a compression of fibers in the fabric liner that remove excess air and resin.
